(19) United States
(12) Patent Application Publication
(10) Pub. No.: US 2019/0303923 A1
(43) Pub. Date: Oct. 3, 2019

(54) METHODS AND SYSTEMS FOR UPDATING CURRENCY PLAN PROFILE FOR PAYMENT CARDS

(71) Applicant: Mastercard International Incorporated, Purchase, NY (US)

(72) Inventors: Amarpreet Singh Arora, Pune (IN); Khushboo Singhal, Pune (IN); Ganesh Shinde, Pune (IN); Dattesh Naik, Pune (IN); Arunmurthy Gurunathan, Pune (IN); Rohit Mali, Pune (IN)

(21) Appl. No.: 16/285,905

(22) Filed: Feb. 26, 2019

(30) Foreign Application Priority Data
Mar. 29, 2018 (SG) 10201802669W

(51) Int. Cl. G06Q 20/38; G06Q 20/34; G06Q 10/02; G06Q 50/14

(52) U.S. Cl. CPC G06Q 20/381; G06Q 50/14; G06Q 10/02; G06Q 20/34

(57) ABSTRACT

Embodiments provide methods, and server systems for updating an existing currency plan profile to a currency plan profile for a payment card. The method includes facilitating, by an issuer server of a payment network, payment transaction between an issuer account associated with a payment card of a customer and an acquirer account associated with a travel booking entity. The payment transaction is associated with a foreign travel booking request. The method further includes generating a currency plan profile for the payment card in response to one or more travel details of the foreign travel booking request. The method includes providing the currency plan profile to the customer for approval of the customer. Upon receipt of the approval from the customer, an existing currency plan profile of the payment card is updated to the currency plan profile for facilitating a future payment transaction from the issuer account in a foreign destination.

### CROSS-REFERENCE TO RELATED APPLICATION

This application is a U.S. National Stage filing under 35 U.S.C. § 119, based on and claiming benefits of and priority to Singapore Patent Application No. 10201802669 W filed on Mar. 29, 2018. The entire disclosure of the above application is incorporated herein by reference for all purposes.

### TECHNICAL FIELD

The present disclosure relates to payment transactions and, more particularly to, methods and systems for enabling a currency plan for the payment card for transactions in foreign destinations.

### BACKGROUND

People travel to various countries for business, work, study, and vacation. For traveling abroad, prior preparation and planning related to travel activities may be required. Travelers indulge in booking travel tickets such as flight ticket, train ticket, bus ticket, accommodation and interstate/intercity transfers through a travel agency or any travel related service providers. However, in the recent times, travel booking is also concluded through online travel booking services.

There may be variations in domestic and destination currencies, which cause inconvenience for performing payment transactions in foreign destinations. Travelers may need to exchange domestic currencies with destination currencies in advance to be used in the destination countries. Often, travelers are seen carrying foreign currencies in cash. Although cash may be a viable option for performing transactions for a shorter stay at a foreign destination, however for a longer duration of stay, it is never an ideal option.

In the current scenario, although cash is still in use, various banks facilitate international payment services in form of payment cards including international debit card, international credit card, prepaid travel card, international mobile wallet, or the like, that make transactions easier in foreign destinations as the travelers do not have to worry about having huge amount of cash in hand. At present, a majority of the world's currencies float freely against each other and the currency exchange rates are never stable. Such variations in the exchange rates may be influenced by many factors related to market fluctuation, government policies, political scenarios or the like. Due to variations, a fixed currency exchange rate may not be determined for the traveler's foreign transactions using payment cards. Further, a fund (spending) limit associated with the payment cards in foreign destinations may not be determined and updated thereby causing inconvenience to travelers to understand how much the travelers can spend.

In some scenarios, the traveler may be required to contact an issuing bank for facilitating fund limits and other related currency exchange information, which may not be feasible in real-time scenarios. For example, the issuing bank may lack to understand and provide services such as creditability fund limit, fixed rate for currency exchange, etc., to the customer during cross-border travel.

Accordingly, there is a need to facilitate a fixed currency plan and fund limit for the payment cards of the traveler based on which transactions are facilitated in foreign destinations.

### SUMMARY

Various embodiments of the present disclosure provide systems, methods, electronic devices and computer program products for updating an existing currency plan profile of a payment card to a currency plan profile for facilitating a future payment transaction in a foreign destination.

In an embodiment, a method is provided. The method includes facilitating, by an issuer server of a payment network, a payment transaction between an issuer account associated with a payment card of a customer and an acquirer account associated with a travel booking entity. The payment transaction is associated with a foreign travel booking request. The method further includes generating, by the issuer server, a currency plan profile for the payment card. The currency plan profile generated in response to one or more travel details of the foreign travel booking request. The method includes providing the currency plan profile to the customer for approval of the customer. The method also includes, upon receipt of the approval of the currency plan profile from the customer, updating an existing currency plan profile of the payment card to the currency plan profile for facilitating a future payment transaction from the issuer account when the payment card is used to make a transaction in a foreign destination of one or more foreign destinations as per the foreign travel booking request.

In another embodiment, an issuer server is provided. The issuer server includes a memory comprising stored instructions. The issuer server includes at least one processor configured to execute the stored instructions to cause the issuer server to perform facilitating a payment transaction between an issuer account associated with a payment card of a customer and an acquirer account associated with a travel booking entity. The payment transaction is associated with a foreign travel booking request. The issuer server is caused to perform generating a currency plan profile for the payment card, wherein the currency plan profile is generated in response to one or more travel details of the foreign travel booking request. The issuer server is further caused to perform providing the currency plan profile to the customer for approval of the customer. The issuer server is also caused to perform, upon receipt of the approval of the currency plan profile from the customer, updating an existing currency plan profile of the payment card to the currency plan profile for facilitating a future payment transaction from the issuer account when the payment card is used to make a transaction in a foreign destination of one or more foreign destinations as per the foreign travel booking request.

In still another embodiment, server method is provided. The method includes facilitating, by a payment server of a payment network, a payment transaction between an issuer account associated with a payment card of a customer and an acquirer account associated with a travel booking entity, wherein the payment transaction is associated with a foreign travel booking request for the customer. The method includes accessing, by the payment server, a currency plan profile for the payment card. The currency plan profile is generated in response to one or more travel details of the foreign travel booking request. The method further includes storing the currency plan profile, upon receipt of approval of the currency plan profile from the customer, in a database accessible to the payment server. The currency plan profile facilitates a future payment transaction by the payment server from the issuer account when the payment card is used to make a transaction in a foreign destination of one or more foreign destinations as per the foreign travel booking request.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 represents a sequence flow diagram representation for facilitating currency plan profile in payment card of a customer, in accordance with an example embodiment of the present disclosure;

FIG. 3 illustrates a customer file representing a currency plan profile, in accordance with an example embodiment of the present disclosure;

FIG. 4 shows an example representation of an account management system file facilitated by an issuer server, in accordance with an example embodiment of the present disclosure;

FIG. 5 represents a sequence flow diagram for deactivation of a currency plan profile for a payment card of a customer in relation to travel booking request cancellation, in accordance with an example embodiment;

FIG. 6 represents another sequence flow diagram representation for deactivation of a currency plan profile for a payment card of a customer, in accordance with an example embodiment;

FIG. 7 represents a sequence flow diagram representation for payment transaction in a foreign destination using a payment card facilitated with currency plan profile, in accordance with yet another example embodiment;

FIG. 8 shows an example representation of an account management system file with currency plan profile and an expense limit in one or more foreign destinations, in accordance with an example embodiment of the present disclosure;

FIG. 9 illustrates a flow diagram of a method for facilitating currency plan profile in payment card of a customer for cross-border travel, in accordance with an example embodiment of the present disclosure;

FIG. 10 illustrates another flow diagram of a method for facilitating currency plan profile in payment card of a customer for cross-border travel, in accordance with an example embodiment of the present disclosure;

FIG. 11 is a simplified block diagram of a server system used for facilitating currency plan profile for one or more payment cards of a customer for cross-border travel, in accordance with one embodiment;

FIG. 12 is a simplified block diagram a travel booking entity interface such as a POS terminal used for payment transactions, in accordance with one embodiment of the present disclosure;

FIG. 13 is a simplified block diagram of an issuer server for facilitating currency plan profile in payment card of a customer for cross-border travel, in accordance with one embodiment of the present disclosure;

FIG. 14 is a simplified block diagram of an acquirer server used for facilitating currency plan profile for one or more payment card of a customer for cross-border travel, in accordance with one embodiment of the present disclosure;

FIG. 15 is a simplified block diagram of a payment server used for facilitating currency plan profile for one or more payment card of a customer for cross-border travel, in accordance with one embodiment of the present disclosure; and

FIG. 16 shows simplified block diagram of a user device, for example, a mobile phone capable of implementing at least some embodiments.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuer account” used throughout the description refers to a financial account that is used to fund the financial transaction (interchangeably referred to as “payment transaction”). Further, the “acquirer account” used throughout the description refers to a financial account of a merchant or any entity which receives the fund from the issuer account. Examples of the issuer account and the acquirer account include, but are not limited to a savings account, a credit account, a checking account and a virtual payment account. Each of the issuer account and the acquirer account may be associated with an entity such as an individual person, a family, a commercial entity, a company, a corporation, a governmental entity, a non-profit organization and the like. In some scenarios, an issuer or acquirer account may be a virtual or temporary payment account that can be mapped or linked to a primary payment account, such as those accounts managed by PayPal®, and the like.

The term “payment card”, used throughout the description, refers to a physical or virtual card linked with a financial or payment account that may be presented to a merchant or any such facility in order to fund a financial transaction via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Overview

Various example embodiments of the present disclosure provide systems, methods, electronic devices and computer program products for updating an existing currency plan profile of a payment card to a currency plan profile for facilitating a future payment transaction in a foreign destination.

In various example embodiments, the present disclosure provides generating a currency plan profile for a payment card of a customer for a cross border travel. A customer may perform a foreign travel booking through a travel booking entity using a web site/application (online booking) or over the booking counter (offline booking). A server, including but not limited to an issuer server, receives the payment transaction request for the foreign travel booking. The payment transaction request includes customer details and a PNR number of the travel booking. The PNR number associated with the foreign travel booking is commonly stored in a global database. Once the payment transaction is complete, the server is configured to access travel details from the global database using the PNR number. Examples of the travel details include, but are not limited to one or more foreign destinations, duration of stay in each of the foreign destinations.

The server generates a currency plan profile for the payment card using the travel details accessed from the global database. The server further sends the currency plan profile to the customer for approval. Upon receiving approval from the customer, an existing currency plan profile of the payment card is updated to a new currency plan profile. Thereafter, all of the future payment transactions, during the entire stay of the customer in any of the foreign destinations (included in the currency plan profile), are facilitated based on the currency plan profile. The currency plan profile includes details of travel base currency in each of the foreign destinations, a base currency in the country where the payment card is issued, a fund limit for the payment card in each of the foreign destinations, conversion factors, validity/expiry details of the currency plan profile, etc. Such currency plan profile is also stored in a payment server associated with payment interchange network. Accordingly, the payment card can be used as multiple currency card for the entire duration of stay of the customer in different foreign destinations, and the customer will be able to make financial transactions in local currency of the foreign destinations as per predefined conversion rates provided in the currency plan profile.

In an example, if an Indian customer has booked a return flight ticket from Mumbai to London and/or also booked accommodation in London using an interface of a travel booking entity. The server system obtains travel details such as travel dates and duration of stay in London using a booking reference number (e.g., PNR number). Based on the travel details, a currency plan profile including travel base currency for the travel duration and optimal currency conversion rates between Indian Rupee (INR) and Great Britain Pound (GBP) (e.g., 1 INR=0.012 GBP) and a fund limit of payment card in GBP, may be offered to the customer. Upon acceptance of the proposed change in the currency plan profile by the customer, the existing currency plan profile (e.g., the base currency being INR) is updated to the new currency plan profile (e.g., with the travel base currency being GBP). Thereafter, all future transactions performed during the stay in London are performed in GBP and later charged to the customer in INR with the exchange rate of 1 INR=0.012 GBP. Various example embodiments also provide methods for deactivation of a currency plan profile for the payment card of the customer.

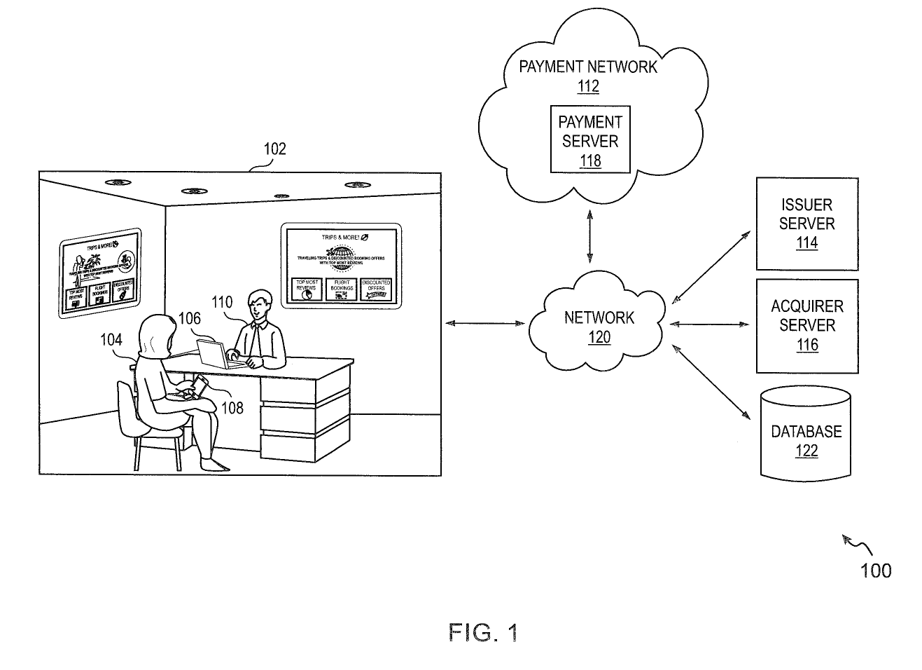

The methods and systems for updating an existing currency plan profile for one or more payment cards of a customer to a currency plan profile for cross border travel are described hereinafter with reference to FIGS. 1 to 16.

FIG. 1 illustrates an example representation of an environment 100, in which at least some example embodiments of the present disclosure can be implemented. The environment 100 as illustrated in FIG. 1 depicts a travel booking entity 102 that facilitates travel booking related services to customers, such as a customer 104. The travel booking entity 102 represents any service provider that facilitates travel booking including domestic and/or foreign travel booking on behalf of the customer 104. It shall be noted that the travel booking entity 102 may be an individual, an entity or a group of individuals. In FIG. 1, the environment 100 depicts a representative/agent 110 associated with the travel booking entity 102, at a payment desk, selling travel booking services to the customer 104 or assisting the customer 104 in purchasing travel booking services. Some examples of the travel booking entity 102 includes but not limited to travel booking websites, airlines, hotels, Visa centers, tour operators, etc. Travel booking within the scope of this disclosure includes foreign travel booking or any booking, which requires customers spending money in a foreign or different currency. Further, foreign travel booking may be interchangeably referred to as travel booking throughout this disclosure.

The travel booking entity 102 includes a travel booking entity interface 106 (hereinafter also referred to as “booking interface 106”). As can be seen from the environment 100, the customer 104 is at the premise of the travel booking entity 102 and making a financial transaction using the booking interface 106. Examples of the booking interface 106 include a point of sale (POS) device or a point of sale (POS) terminal placed on a payment desk using which the payment transaction can be initiated. In other examples, the booking interface 106 can be a telephone or a computer system operated by the agent 110 for performing travel booking on behalf of the customer 104. As seen in FIG. 1, the booking interface 106 is a computer system operated by the agent 110. Alternatively, or additionally, the booking interface 106 can also be an online interface such as a travel booking entity website, mobile or desktop applications, or third party websites or applications using which the customer 104 may perform travel booking from a remote location such as the customer's home or with in-store presence.

A payment transaction between the customer 104 and the travel booking entity 102 may be facilitated by one or more server systems and a payment network. Examples of the one or more server systems include an issuer server 114, an acquirer server 116 and a payment server 118.

The customer 104 may operate a customer device 108 (hereinafter known as device 108) to perform travel booking from remote locations (such as the customer's home). The device 108 may include electronic devices such as smart phones, laptops, computers, and/or the like. The device 108 may be any device, not limited to the devices mentioned above, that has communication capabilities and support applications such as web applications, mobile applications facilitated by the travel booking entity 102 for performing foreign and/or domestic travel booking. The foreign travel booking may be performed in an online mode or an offline mode. In the online mode, the customer 104 performs the foreign travel booking from a remote location by accessing the web application or the mobile application at the device 108. In the offline mode, the customer 104 can walk into the premises of the travel booking entity 102 as seen in FIG. 1 to request the travel booking entity 102 to perform the travel booking.

The travel booking entity 102 may be associated with one or more service provider entities such as airlines, hotels, resorts, sightseeing tour operators, car rentals, cruises, railways etc. The foreign travel booking may include the services provided by the one or more service provider entities. The travel booking entity 102 may aggregate the services provided by the one or more service provider entities on a platform such as the booking interface 106 or the web or mobile application accessed using the device 108, such that while performing the travel booking, a customer (e.g., the customer 104) or a travel booking entity (e.g., the travel booking entity 102) can book one or more of the services. The services may be available as individual services or as packages/combination of one or more services.

For foreign travel booking, the customer 104 is required to enter customer details (such as name, destinations, duration of stay, preferences related to airlines, travel time, preferences related to accommodation, etc.) in the application at the device 108. Alternatively, the customer details are being captured by the travel booking entity 102 through various means, such as asking questions to the customer, forms filled by the customer, etc., at the booking interface 106.

A payment transaction request is initiated at the booking interface 106 for the foreign travel booking. The payment transaction request may include a fare associated with the foreign travel booking and a travel booking reference number. Examples of the travel booking reference number may include a Passenger Name Record (PNR) number or a booking identification (booking ID) assigned by the travel booking entity 102. The payment transaction request along with the customer details is received by the acquirer server 116 (an example server system) which sends it to the issuer server 114 (an example server system) through a payment network 112 facilitated by the payment server 118 (an example server system). In some cases, the issuer server 114, the acquirer server 116 and the payment server 118 can be a single entity, or any two of these servers may be a single entity.

The issuer server 114 authenticates the customer 104 and debits funds equal in amount to the fare associated with the foreign travel booking from an issuer account of the customer 104. The payment is passed to an acquirer account associated with the travel booking entity 102 to complete the payment transaction and confirm the foreign travel booking.

In one embodiment, the payment server 118 is associated with the payment network 112. The payment network 112 may be used by payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.).

The issuer server 114 is associated with a financial institution normally called as an “issuer bank” or “issuing bank” or simply “issuer”, in which the customer 104 may have an account, which issues one or more payment cards, such as a credit card or a debit card. The payment cards are linked to a unique payment account number of the customer 104. The unique account number, as an example, can be a PAN number assigned to tax payers in India. The customer 104, being the cardholder, can use any of the payment cards to tender payment for the travel booking.

The acquirer server 116 is associated with a financial institution normally called as an “merchant bank” or the “acquiring bank” or “acquirer bank” or simply “acquirer”, in which the travel booking entity 102 or the service provider entities may have account. The acquirer server 116 is associated with the acquirer bank. It shall be noted that an acquirer associated with the travel booking entity 102 may first receive the payment from the issuer account of the customer 104. The payment may later be disbursed to acquirers of associated service provider entities upon confirmation of service booking. In another embodiment, the environment 100 may include a plurality of acquirer servers and a plurality of acquirers associated with the one or more service provider entities including the travel booking entity 102. Similarly, the environment 100 may include a plurality of issuer servers associated with a plurality of issuers, wherein the customer 104 may have financial accounts in each of the issuers.

Using the payment network 112 one or more systems of the acquirer/acquirer server 116 will communicate with one or more systems of the issuer/issuer server 114 to determine whether the customer's account is in good standing and whether the fare associated with the travel booking is covered by the customer's available account balance. Based on these determinations, authorization of the payment transaction is declined or accepted. When the authorization is accepted, the available balance of customer's account is decreased.

The device 108, the issuer server 114, the acquirer server 116 and the payment server 118 communicate with one another using a network 120. Similarly, the device (e.g., a mobile phone or desktop computer) associated with the booking interface 106, the issuer server 114, the acquirer server 116 and the payment server 118 communicate with the network 120. Examples of the network 120 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 120 may be or include the Internet, intranets, extranets, microwave networks, satellite communications, cellular systems, personal communication services (“PCS”), infrared communications, global area networks, or other suitable networks, etc., or any combination of two or more such networks.

Further, the environment 100 is depicted to include a global database 122. In one example, the global database 122 may store one or more travel details of a plurality of customers including the customer 104. For instance, the global database 122 fetches information from various travel booking entities, airlines, hotels, etc., against PNR number, booking IDs, and stores the information on a temporary or permanent basis. As an example, the global database 122 may include the customer details such as a name, an address, contact information, the travel booking reference number (PNR number), the duration of stay and destinations, among others. The global database 122 may further include information related to status of the travel booking, wherein the status may be ‘active’, ‘completed’, ‘upcoming’, cancelled, postponed, etc. Furthermore, the global database 122 may include information related to history of travel activities and travel bookings by the customer 104. In an example embodiment, the global database 122 may be associated with the travel booking entity 102.

The issuer server 114 also includes an issuer database (not shown in FIG. 1) for maintaining customer details such as one or more issuer accounts of the customer 104, details of one or more payment cards of the customer 104, transaction history related information, the unique account number (PAN) with which the one or more one or more issuer accounts and the one or more payment cards are linked, validity/expiry of payment cards, etc. The issuer server 114 and the global database 122 can be in operative communication with one another.

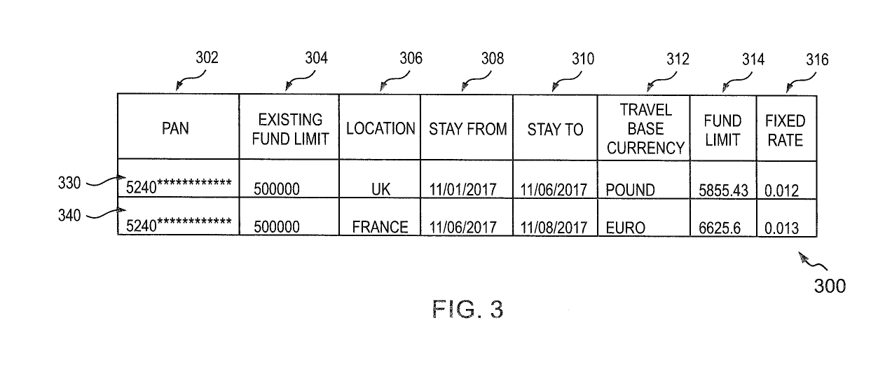

It is noted that a payment card of the customer 104 may have an associated default currency plan profile. For instance, if the customer 104 is in India, and the payment card is issued from the issuer in India, the existing (or base/default) currency plan profile of the payment card include Indian Rupee (INR) as a base currency, and the fund limit of the payment card is a pre-defined amount in INR. For example, the default currency plan profile for the payment card includes Currency: INR, and fund limit: 1,00,000 INR. When the customer 104 makes a foreign travel booking using the payment card, in an embodiment, the issuer server 114 electronically generates a new currency plan profile for the payment card. The issuer server 114 generates the currency plan profile based on information related to the travel booking, and stores corresponding details of the currency plan profile in the issuer database. In an example, the issuer server 114 determines a base currency and an exchange rate of the base currency based on information extracted using the travel booking reference number such as names of foreign destinations, duration of stay in each of the foreign destinations, etc. The issuer server 114 further provides the currency plan profile to the customer 104 through various means, such as email, text message, etc., for approval of the customer. Upon receiving approval of the currency plan profile from the customer 104, the issuer server 114 updates the existing currency plan profile with the currency plan profile approved by the customer 104. The issuer server 114 also updates the payment server 118 with the changes in the currency plan profile of the payment card, and the payment server 118 updates the currency plan profile in its database. The issuer server 114 stores the updated customer details in a customer file (see 300 in FIG. 3) in the issuer database. The updated customer details are further stored in an account management system (AMS) file associated with the payment server 118. The AMS may also be accessible to the issuer server 114.

In some example scenarios, the issuer server 114 may generate the currency plan profile including an improved and competitive exchange rate of currency. The improved exchange rate includes an exchange rate which is better in terms of benefits than a default exchange rate that is being offered in market by third party agencies and financial institutes such as an issuer bank. It shall be noted that the improved exchange rate is specific for specific foreign destinations, specific merchants in those foreign destinations and one or more deals that an issuer associated with the issuer server 114 has with different merchants in those foreign destinations. The issuer server 114 further provides the currency plan profile including the improved exchange rate to the customer 104 through various means, such as email, text message, etc., for approval of the customer. Upon receiving approval of the currency plan profile from the customer 104, the issuer server 114 updates the existing currency plan profile with the currency plan profile approved by the customer 104. However, if a customer chooses not to approve the currency plan profile including the improved exchange rate, the issuer server 114 updates the existing currency plan profile with the currency plan profile including a default exchange rate. It shall be noted that the currency plan profile including an improved and competitive exchange rate is generated under certain circumstances, such as, specific foreign destinations, one or more deals with specific merchants in the foreign destinations.

Once, the currency plan profile is updated, the payment network 112 enables future financial transactions at the foreign destinations to be carried out based on the determined exchange rates as per the currency plan profile for the payment card. The currency plan profile may include, information related to one or more foreign destinations, duration of stay in each of the one or more foreign destinations, improved/competitive exchange rates of base currency or default exchange rates of base currency as determined and approved by the customer, a fund limit for the payment card in each of the one or more foreign destinations, a validity/expiry associated with the payment card and a validity/expiry of the currency plan profile.

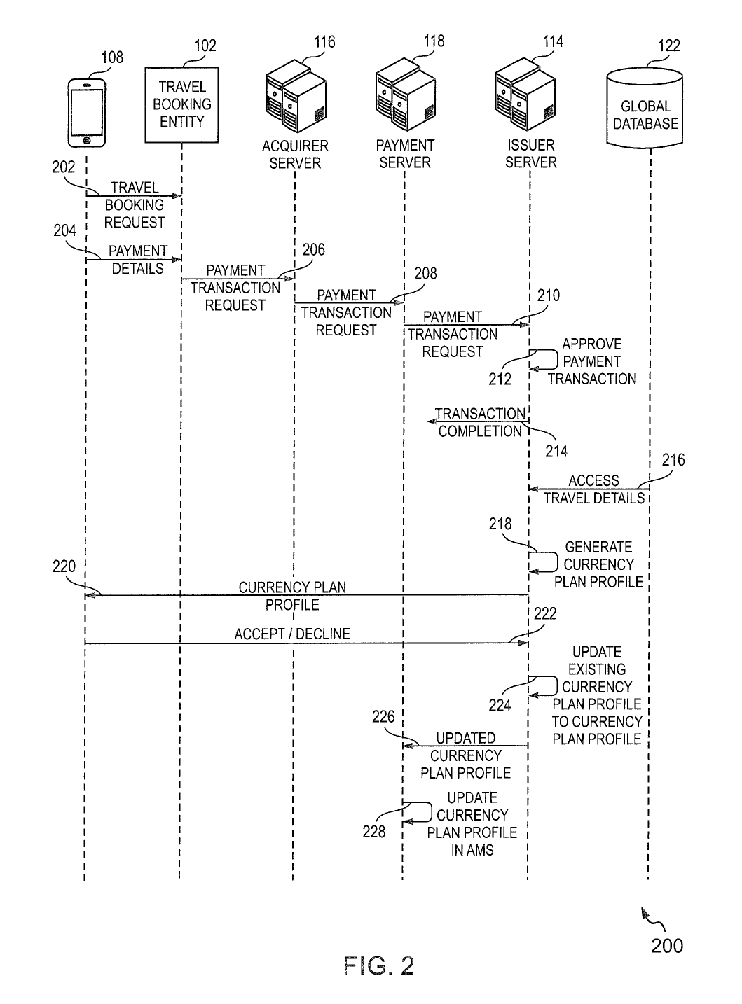

FIG. 2 represents a sequence flow diagram 200 for updating an existing currency plan profile to a currency plan profile based on information related to the travel booking of the customer 104, in accordance with an example embodiment of the present disclosure. Updating an existing currency plan profile may include either entirely replacing the existing currency plan profile with the currency plan profile generated by the issuer sever 114, or making modifications (such as adding plans, editing plans, editing exchange rates, etc.) in the existing currency plan profile as per the generated currency plan profile. The customer 104 associated with the device 108 as described with reference to FIG. 1, initiates the travel booking by sending a travel booking request to the travel booking entity 102 using the device 108.

At 202, the travel booking request is sent to the travel booking entity 102 from the device 108. The travel booking request may include customer details including the customer's name, address, contact information, travelers' details such as names, age and gender of travelers, among others. Further, the travel booking request may include travel related information such as flight preference, seat preference, travel time preference, accommodation preference, duration of stay (trip start date and trip end date), one or more foreign destinations, duration of stay at each of the foreign destinations, etc. In an alternate embodiment, the travel booking request may be generated by the agent 110 at the booking interface 106 upon receiving the customer details required to perform the travel booking.

Upon reception of the travel booking request from the customer 104, the customer 104 may be presented with the fare associated with the travel booking and is prompted to provide payment details. At 204, the customer 104 provides the payment details of the payment card to the travel booking entity 102. The payment details may include one or more of an issuer account number, a payment card number, CVV details, expiry date of the payment card, etc. In an example, once the payment details are received by the booking entity 102, a travel booking reference number may be generated.

At 206, the travel booking entity 102 sends a payment transaction request to the acquirer server 116. It may be noted that the payment transaction request includes the travel booking reference number (e.g., PNR) and details of the payment card of the customer 104. The acquirer server 116 receives the payment transaction request. At 208, the acquirer server 116 sends the payment transaction request to the payment server 118.

At 210, the payment server 118 sends the payment transaction request to the issuer server 114. At 212, the issuer server 114, after the verification process of the payment card of the customer 104, approves the transaction requests, and processes the payment from the issuer account to the acquirer account via the payment server 118. Details of the payment transaction from the issuer account to the acquirer account are not provided herein in detail for the sake of brevity. For instance, in a non-limiting example, the issuer server 114 generates an authentication code such as a fixed character length PIN or a fixed character length one time password (OTP). The issuer server 114 sends the authentication code to at least one registered contact (e.g., phone number and/or email account) of the customer 104. As an example, if the same authentication code is received from the customer 104, the customer 104 will be validated and authenticated by the issuer. At 214, the payment transaction is shown as completed.

The travel booking reference number of the customer 104 is stored against customer details (name, address, contact information, age and gender, among others) in the global database 122.

At 216, the issuer server 114 accesses the global database 122 to retrieve travel details associated with the travel booking reference number (i.e. PNR) of the customer 104. The issuer server 114 retrieves the travel details corresponding to the PNR such as the one or more foreign destinations, duration of stay in each of these foreign destinations, overall duration of stay, etc., of the customer 104.

At 218, the issuer server 114 generates a currency plan profile based on the travel details. The currency plan profile includes base currency details, base currency exchange rates for each of the one or more foreign destination, payment card limit (e.g., debit limit, cash withdrawal limit, fund limit) for the issuer account linked to the payment card, etc. It shall be noted that the currency plan profile may be updated for one or more payment cards associated with one or more financial accounts of the customer 104 with the same issuer. The issuer server 114 may retrieve information corresponding to the one or more payment cards and the one or more financial accounts from the unique account number (PAN number) of the customer 104 stored in the issuer database. In some example scenarios, such as for specific foreign destinations, deals with specific merchants in the foreign destinations, the issuer server 114 may generate the currency plan profile including an improved and competitive exchange rate. The improved exchange rate includes an exchange rate which is better in terms of benefits than a default exchange rate.

At 220, a notification representing the currency plan profile is sent to a customer account of the customer 104 with the issuer. For instance, when the customer 104 logs in into the customer account on a website/portal/application of the issuer, the customer 104 can see the notification of the currency plan profile. In some forms, the notification may be provided as a text message to a registered contact number of the customer 104. Additionally or alternatively, the notification may be sent in form of an email to an email ID registered with the customer account. The notification includes actionable links or prompts for the customer 104 to either accept or decline the currency plan profile. In some scenarios as discussed above, the issuer server 114 may also provide the currency plan profile including the improved exchange rate to the customer 104 as a notification for approval of the customer 104.

At 222, the customer 104 provides a response to the notification by either accepting or declining the currency plan profile. When the customer 104 declines, the currency plan profile will not be updated for the one or more payment cards of the customer 104. However, when the customer 104 accepts, the currency plan profile will be updated for the payment card of the customer 104. Likewise, the notification may include the currency plan profile including the improved exchange rate. When the customer 104 declines, the currency plan profile will not be updated for the one or more payment cards of the customer 104 or the currency plan profile including default exchange rates will be updated. When the customer 104 accepts, the currency plan profile including the improved exchange rates will be updated for the payment card of the customer 104.

At 224, the issuer server 114 updates the existing currency plan profile for the payment card to the currency plan profile (determined at 218) in the issuer database associated with the issuer server 114.

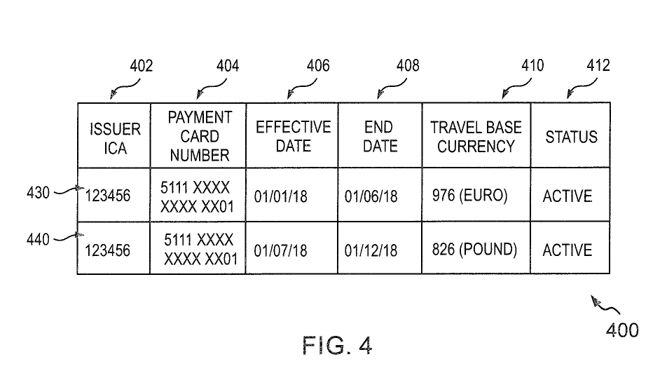

At 226, the issuer server 114 provides the updated details of the payment card including the currency plan profile to the payment server 118. At 228, the payment server 118 updates the existing currency plan profile with the currency plan profile in an AMS file (see 400 in FIG. 4) associated with the payment server 118. In an embodiment, the issuer server 114 sends a file containing details of the currency plan profile in the AMS file, which can replace the earlier AMS file stored with the payment server 118.

The issuer server 114 then facilitates the currency plan profile for making future transactions in one or more foreign destinations with foreign merchants. It shall be noted that the payment card can be used as a multiple currency card for the entire duration of stay. Further, the payment card may be operable as a local payment card in the foreign destinations.

In an example scenario, the one or more travel details can be retrieved using the travel booking reference number from the global database 122. In another example scenario, travel details can directly be retrieved from the information provided by the customer while making the foreign travel booking request. For instance, the customer 104 may provide a travel duration mentioning a start date and an end date in one or more foreign destinations.

As the currency plan profile is stored in the AMS file with the payment server 118, any future payment during the days of stay at foreign destination is performed as per the updated currency plan profile. Some example representations of the currency plan profile and content of the AMS file are explained further with reference to FIGS. 3 and 4, respectively.

FIG. 3 illustrates an example representation of a customer file 300 representing a currency plan profile stored in the issuer database, in accordance with an example embodiment of the present disclosure. As an example, a customer (such as the customer 104) is on a business trip where he will be traveling to the United Kingdom (UK) for five months and France for two months. As shown in FIG. 3, the customer file 300 is facilitated by the issuer server 114 and includes a listing of travel details (as represented by rows 330 and 340). The columns of the customer file 300 represent two currency plan profiles of a payment card of the customer 104 for facilitating transactions in UK and France.

The columns include a PAN field 302, an existing fund limit field 304, a location field 306, a stay from field 308, a stay to field 310, a travel base currency field 312, a fund limit field 314 and a fixed rate field 316. The row 330 represents a first currency plan profile for a first destination for the payment card of the customer 104. As an example, the row 330 depicts that for the customer with the PAN ‘5240************’, existing fund limit is ‘500000’, location is ‘UK’, stay from ‘11/01/2017’ till ‘11/06/2017’, travel base currency is ‘Pound’, fund limit is ‘5855.43’, and the fixed rate is ‘0.012’. Likewise, the row 340 illustrates a second currency plan profile for the same payment card as in the row 330 for a second destination. The row 340 depicts that for the customer 104 with the PAN ‘5240************’, existing fund limit is ‘500000’, location is ‘France’, stay from ‘11/06/2017’ till ‘11/08/2017’, travel base currency is ‘Euro’, limit is ‘6625.0’, and the fixed rate is ‘0.013’. The fixed rate may be an example of an improved exchange rate or a default exchange rate. Herein, the existing fund limit is a value expressed in a base currency (e.g., Indian Rupees, if the payment card is issued in India) of the customer 104.

In an embodiment, the issuer server 114 facilitates a temporary enhancement of a default fund limit or creating a separate travel fund limit during travel period only for transactions involving foreign currency. It shall be noted that the default fund limit includes funds that the customer 104 can use for normal transactions which do not involve paying in the travel base currency or purchase from any foreign merchants. The travel fund limit includes funds that the customer 104 can use for performing transactions that involve (travel base currency) foreign currency and foreign merchants. For example, a customer travelling from Mumbai to London can use his payment card for normal transactions, i.e. purchase from any merchant in India and shipping to India from the default fund limit without impacting the travel fund limit. However, using funds from the travel fund limit will be prevented for normal transactions if the default fund limit is exhausted during the duration of stay.

In an embodiment, payment card details, such as expiry dates of payment cards, suspension of payment cards, and/or the like are stored in the issuer database as well as the AMS file (see 400 in FIG. 4). The payment server 118 may receive updated details of the currency plan profile from the issuer server 114 or the issuer database. The issuer server 114 sends the updated customer file 300 to the payment server 118. The payment server 118 accordingly updates the AMS file associated with the payment card based on the customer file 300. One example of content of the AMS file is described with reference to FIG. 4.

FIG. 4 shows an example representation of the AMS file 400 facilitated by the payment server 118, in accordance with an example embodiment of the present disclosure. As shown, the AMS file 400 includes a listing of payment cards of the customer 104 (as represented by rows 430 and 440). The columns of the AMS file 400 represent a plurality of currency plan profile based parameters for the customer 104. For example, columns include an Issuer Interbank Card Association (ICA) field 402, a payment card number field 404, an effective date field 406, an end date field 408, a travel base currency field 410 and a status field 412. It may be noted that the ICA identification is assigned by Mastercard® for use to uniquely identify the issuer of the payment card. As an example, the row 430 represents that for the issuer ICA ‘123456’, the payment card no. is ‘5111 XXXX XXXX XX01’, the effective date is ‘01/01/18’, the end date is ‘01/06/18’, the travel base currency is ‘976 (in Euros)’, and the status is ‘Active’. Likewise, the row 440 represents that for the issuer ICA ‘123456’, the payment card no. is ‘5111 XXXX XXXX XX01’, the effective date is ‘01/07/18’, the end date is ‘01/08/18’, the travel base currency is ‘826 (in Pounds)’, and the status is ‘Active’. The effective date as depicted by field 406 may correspond to a date on which the currency plan profile is updated for the payment card as depicted in field 404. The end date as depicted by field 408 may correspond to a date on which the currency plan profile expires for the payment card as depicted in field 404. The status in the status field 412 may correspond to the status of the currency plan profile for the payment card.

The payment server 118 and the payment network 112 facilitate transactions at the foreign destinations based on the currency plan profile. It shall be noted that the issuer server 114 will have authorization to update the currency plan profile for one or more payment cards issued by an issuer associated with the issuer server 114. Similarly, for other issuers, not associated with the issuer server 114, the payment server 118, may communicate with the respective issuer servers through the payment network 112 for updating currency plan profiles for one or more payment cards.

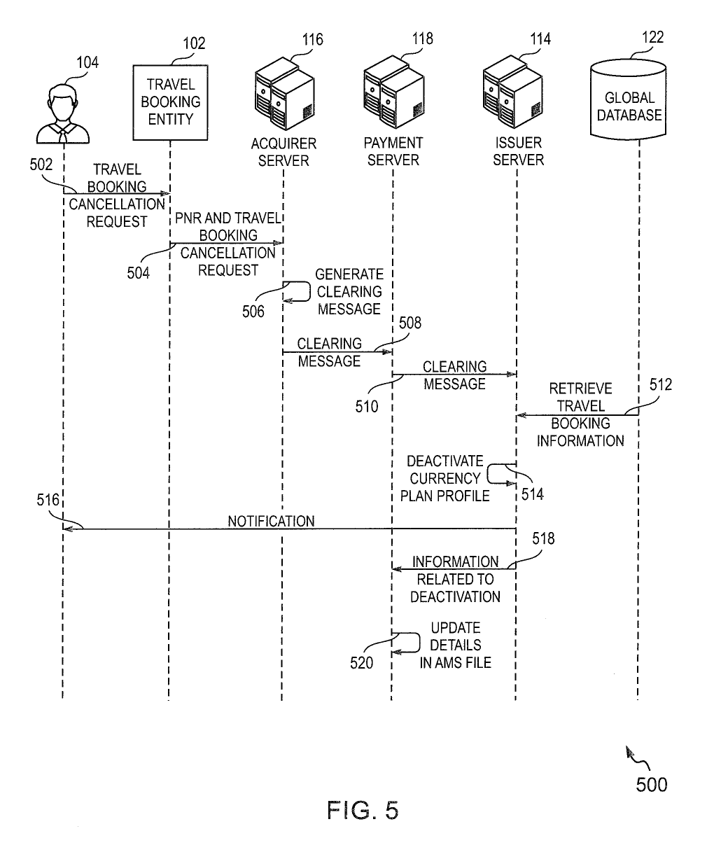

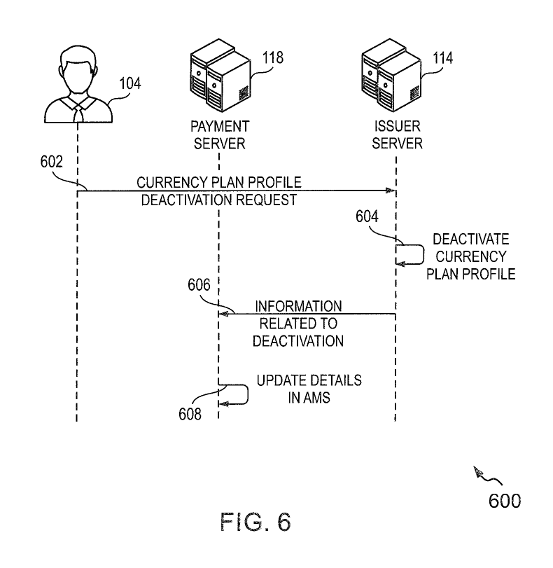

In some scenarios, the customer 104 may wish to cancel the currency plan profile for the payment card. In one example scenario, the currency plan profile for the payment card may be deactivated in response to travel booking cancellations, which is explained in detail with reference to FIG. 5. Travel booking cancellations may be initiated either by customers themselves or by the travel booking entity 102. In another example scenario, the customer 104 may directly deactivate the currency plan profile with an interface provided by the issuer server 114, without having a need to cancel the travel booking through the travel booking entity 102, which is explained in detail with reference to FIG. 6.

FIG. 5 represents a sequence flow diagram 500 illustrating deactivation of a currency plan profile by the customer 104 based on travel booking cancellation initiated by the customer 104, in accordance with an example embodiment.

At 502, the customer 104 sends a travel booking cancellation request to the travel booking entity 102. The web application or the mobile application of the travel booking entity 102 may provide options to the customer 104 to initiate the travel booking cancellation request. The travel booking cancellation request may include the travel booking reference number along with the customer details. At 504, the travel booking entity 102 provides the travel booking reference number along with the travel booking cancellation request to the acquirer server 116.

At 506, the acquirer server 116 generates a clearing message. It may be noted that the clearing message includes the travel booking cancellation request and reason for cancellation, which may be optional. The clearing message may further include information associated with a cancellation charge based on standard policies.

At 508, the acquirer server 116 provides the clearing message (including the travel booking cancellation request) to the payment server 118.

At 510, the payment server 118 transfers the clearing message to the issuer server 114. It may be noted after receiving the clearing message the issuer server 114 sends a message to the acquirer server 116 via the payment network 112 requesting initiation of refund for the cancellation. The message may include a refund amount and details of the customer's issuer account where the refund amount has to be transferred. Steps related to the refund of the amount are not described herein for the sake of brevity.

At 512, once the refund transaction is approved, the issuer server 114 retrieves travel booking information using the travel booking reference number from the global database 122. The travel information retrieved includes travel status, travel duration, one or more foreign destinations, currency exchange information, etc.

At 514, the issuer server 114 deactivates the currency plan profile of the payment card using the travel booking information. In an embodiment, deactivating the currency plan profile further includes re-activating a default currency plan profile for the payment card. The default currency plan profile is the existing plan profile assigned to the payment card by the issuer for making financial transaction in the home country where the payment card is issued.

At 516, the issuer server 114 notifies the customer 104 of the deactivation of the currency plan profile. The notification is received at the customer account which can be accessed using the device 108. The notification may be in form of a text message and/or an email. The notification may further include an option to be selected by the customer 104 to acknowledge receipt of deactivated currency plan profile, and re-activation of the default currency plan profile.

At 518, the issuer server 114 sends information related to deactivation of the currency plan profile to the payment server 118. It may be noted that the information related to deactivation of the currency plan profile is sent along with a unique verification number of the customer 104. At 520, the payment server 118 updates the currency plan profile with the default currency plan profile and stores it in the AMS file (such as the AMS file 400).

FIG. 6 represents a sequence flow diagram 600 for deactivation of currency plan profile of the customer 104 without travel booking cancellation, in accordance with an example embodiment. The customer 104 may directly login to customer account provided by the issuer server 114 for deactivating the currency plan profile. It may be understood that the customer 104 may access the customer account through web applications, mobile applications, web portals, or the like, facilitated by the issuer server 114 using the device 108 as described with reference to FIG. 1.

At 602, the customer 104 sends a currency plan profile deactivation request to the issuer server 114 by selecting a deactivate currency plan profile option provided on an interface (not shown) provided by the issuer server 114. The currency plan profile deactivation request may also include a reason for deactivation, which may be optional. At 604, the issuer server 114 deactivates the currency plan profile upon receiving the currency plan profile deactivation request. The issuer server 114 may authenticate the customer 104 to check if the request is raised by an authorized customer (such as the customer 104) using authentication techniques described with reference to FIG. 2. Upon successful authentication, the issuer server 114 deactivates the currency plan profile and accordingly re-activates the default currency plan profile for the payment card. At 606, the issuer server 114 sends information of the deactivation of the currency plan profile to the payment server 118.

At 608, the payment server 118 updates the currency plan profile in the AMS file (such as the AMS file 400) i.e. stores the default currency plan profile. It may be noted that the update will be visible in the customer file 300 and the AMS file 400 discussed earlier.

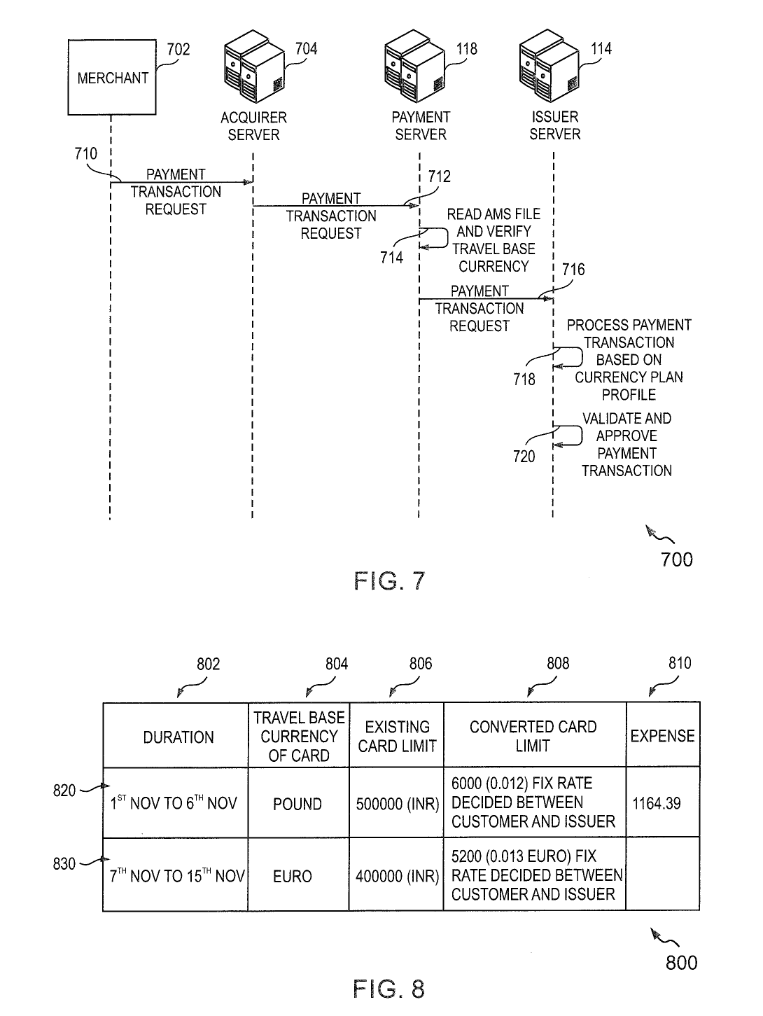

As described herein, the issuer server 114 and the payment server 118 facilitate transactions using the payment card in any of the foreign destinations listed in the currency plan profile, based on the currency plan profile currently stored in the AMS file 400. One example of a payment transaction in a foreign destination is explained in detail with reference to FIG. 7.

FIG. 7 represents a sequence flow diagram 700 for facilitating transactions in foreign destinations using a payment card using a currency plan profile of the payment card, in accordance with an example embodiment. In an example scenario, a customer (such as the customer 104) travels from Mumbai to London. During the stay in London, the customer purchases an item that costs £50 from a merchant 702. The merchant 702 may be an example of a coffee shop, a book stall, a shopping mall, a play station house, and/or the like that accepts a local currency/travel base currency (e.g., Great Britain Pound (GBP)) of London which is different from the domestic currency/base currency (e.g., INR) of the payment card. The merchant 702 may have a financial account managed by an acquirer (see, an acquirer server 704). The acquirer server 704 may be an example of the acquirer server 116 described in FIG. 1. The customer may perform payment transaction for purchasing the item using the payment card in local currency i.e. in GBP. The payment server 118 verifies the currency plan profile for the payment card and the transaction may be approved by the issuer server 114.

At 710, the merchant 702 sends a payment transaction request to the acquirer server 704. At 712, the acquirer server 704 sends the payment transaction request to the payment server 118. At 714, the payment server 118 reads the AMS file (e.g., the AMS file 400) and verifies the travel base currency for the payment card.

At 716, the payment server 118 sends the payment transaction request to the issuer server 114. It may be noted that the payment transaction request may include a purchase amount i.e. £50 made with the merchant 702. At 718, the issuer server 114 receives and processes the payment transaction in GBP. At 720, the issuer server 114 performs validation of the request and accordingly approves the payment transaction.

In an embodiment, the issuer server 114 may also facilitate a fund limit (spending or expense limit) for a payment card based on the availability of funds in an account (or account balance) associated with the payment card. The fund limit may also be determined based on the destination, duration of stay at the destination, travel base currency at the destination and an exchange rate of travel base currency and home currency, which is explained in detail with reference to FIG. 8. The issuer server 114 may provide updated fund limit to the customer 104 based on updated account balance.

FIG. 8 illustrates an example representation of an AMS file 800 (similar to the AMS file 400) with a currency plan profile, in accordance with an example embodiment of the present disclosure. As shown in FIG. 8, the AMS file 800 stored with the payment server 118 includes information of an existing fund limit, a converted card limit, and an account balance for the payment card (as represented by rows 820 and 830). In a non-limiting example, the columns of the AMS file 800 includes a duration field 802, a travel base currency of payment card field 804, an existing credit limit field 806, a converted card limit field 808 and an expense field 810. In this example, the domestic currency for the customer 104 is taken as INR. It is assumed that the customer 104 stays in London between 1^{st} November and 6^{th} November’ and travels to France on 7^{th} November and stays in France from 7^{th} November-15^{th} November. As an example, the row 820 represents that for the duration ‘1^{st} November-6^{th} November’, the travel base currency of payment card 804 is ‘Pound’, the existing credit limit 806 is ‘500000’, the converted card limit 808 is ‘6000 (with Fixed rate 0.012 decided between the customer and Issuer and other transaction charges)’. As shown in the AMS file 800, the customer has already spent £ 1164.39 in London, and accordingly the existing card limit and the converted card limit are reduced for financial transaction in France. As shown in the illustrated example of FIG. 8, the row 830 represents that for the duration 7^{th} November-15^{th} November’, travel base currency of payment card is ‘Euro’, existing credit limit is ‘400000’, converted card limit is ‘5200 (with Fixed rate 0.013 decided between the customer and Issuer and other transaction charges)’. Accordingly, the AMS file 800 is updated dynamically when the customer moves from one foreign destination to another foreign destination.

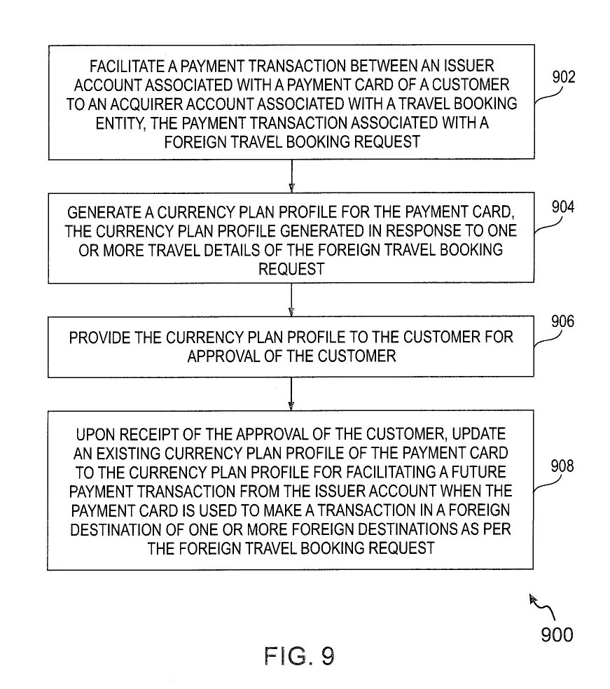

FIG. 9 illustrates a flow diagram of a method 900 for updating an existing currency plan profile for one or more payment cards to a currency plan profile for cross-border travel, in accordance with an example embodiment. The method 900 depicted in the flow diagram may be executed by, for example, the issuer server 114, Operations of the flow diagram 900, and combinations of operation in the flow diagram 900, may be implemented by, for example, hardware, firmware, a processor, circuitry and/or a different device associated with the execution of software that includes one or more computer program instructions. The operations of the method 900 are described herein with help of the issuer server 114. It is noted that the operations of the method 900 can be described and/or practiced by using a system other than the issuer server 114. The method 900 starts at operation 902.

At 902, the method 900 includes facilitating, by an issuer server of a payment network, a payment transaction between an issuer account associated with a payment card of a customer to an acquirer account associated with a travel booking entity. The payment transaction is associated with a foreign travel booking request. The foreign travel booking request can be initiated by the customer in an offline or an online mode. Herein, offline mode represents a travel booking done over phone or by visiting a counter of the travel booking entity. Further, online mode refers to travel bookings made using an online interface associated with the travel booking entity. The travel booking entity sends the payment transaction request to the acquirer server, which sends the payment transaction request to the issuer server through the payment network of the payment server. The issuer server authenticates or verifies the customer and completes the transaction.

At 904, the method 900 includes generating, by the server system, a currency plan profile for the payment card, where the currency plan profile is generated in response to one or more travel details of the foreign travel booking request. The one or more booking details may include one or more foreign destinations and a duration of stay in each of the one or more foreign destinations.

At 906, the method 900 includes, providing the currency plan profile to the customer for approval of the customer. The issuer server sends a notification representing the currency plan profile to the customer for approval.

At 908, the method 900 includes, upon receipt of the approval of the customer, updating an existing currency plan profile of the payment card to the currency plan profile for facilitating a future payment transaction from the issuer account when the payment card is used to make a transaction in a foreign destination of one or more foreign destinations as per the foreign travel booking request. Herein updating can refer to adding or appending the currency plan profile to the existing currency plan profile for payment card. The method 900 ends at 908.

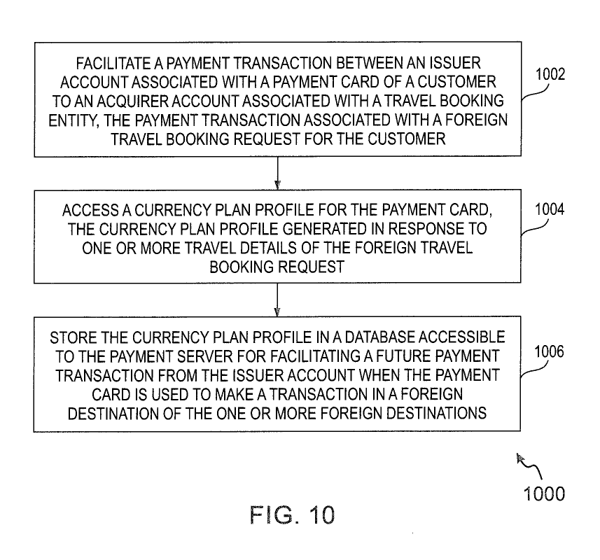

FIG. 10 illustrates a flow diagram of a method 1000 for updating an existing currency plan profile for one or more payment cards to a currency plan profile for cross-border travel, in accordance with an example embodiment. The method 900 depicted in the flow diagram may be executed by, for example, the payment server 118, Operations of the flow diagram 1000, and combinations of operation in the flow diagram 1000, may be implemented by, for example, hardware, firmware, a processor, circuitry and/or a different device associated with the execution of software that includes one or more computer program instructions. The operations of the method 1000 are described herein with help of the payment server 118. It is noted that the operations of the method 1000 can be described and/or practiced by using a system other than the payment server 118. The method 1000 starts at operation 1002.

At 1002, method 1000 includes, facilitating, by a payment server of a payment network, a payment transaction between an issuer account associated with a payment card of a customer to an acquirer account associated with a travel booking entity, where the payment transaction is associated with a foreign travel booking request for the customer.

At 1004, the method 1000 includes, accessing, by the payment server, a currency plan profile for the payment card. The currency plan profile is generated in response to one or more travel details of the foreign travel booking request.

At 1006, the method 1000 includes, storing the currency plan profile in a database accessible to the payment server. The currency plan profile facilitates a future payment transaction by the payment server from the issuer account when the payment card is used to make a transaction in a foreign destination of one or more foreign destinations as per the foreign travel booking request. The currency plan profile may be stored in an AMS file (such as the AMS files 400 and 800) against details of the customer. The details of the customer may include customer's name, contact, address, travel booking information and history of travel related activities, among others. The method 1000 ends at 1006.

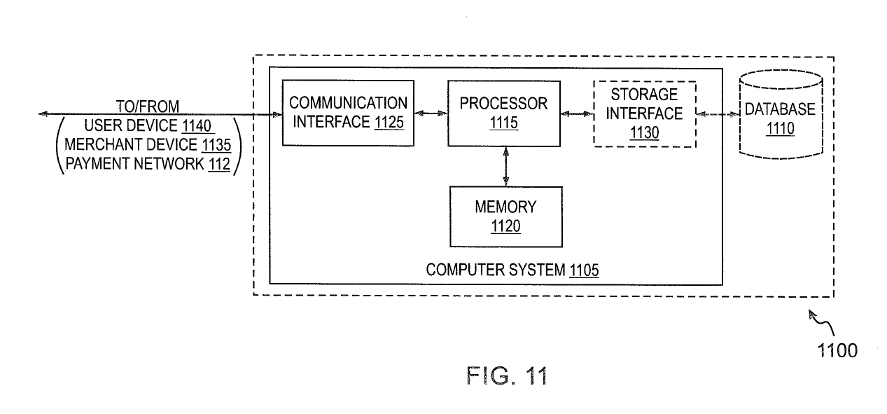

FIG. 11 is a simplified block diagram of a server system 1100 used for updating an existing currency plan profile for one or more payment cards of a customer to a currency plan profile for cross-border travel, in accordance with one embodiment of the present disclosure. The server system 1100 is an example of a server system that is a part of the payment network 112. Examples of the server system 1100 includes, but not limited to, the acquirer server 116, the payment server 118 and the issuer server 114. The server system 1100 includes a computer system 1105 and a database 1110.

The computer system 1105 includes at least one processor 1115 for executing instructions. Instructions may be stored in, for example, but not limited to, a memory 1120. The processor 1115 may include one or more processing units (e.g., in a multi-core configuration).

The processor 1115 is operatively coupled to a communication interface 1125 such that the computer system 1105 is capable of communicating with a remote device such as a merchant device 1135 (e.g., the booking interface 106) or a user device 1140 (such as the device 108) or communicating with any entity within the payment network 112. For example, the communication interface 1125 may receive the payment transaction request, where the payment transaction request is generated in response to travel booking request.

The processor 1115 may also be operatively coupled to the database 1110. The database 1110 is any computer-operated hardware suitable for storing and/or retrieving data, such as, but not limited to, transaction data generated as part of sales activities conducted over the bankcard network including data relating to merchants, account holders or customers, and purchases. The database 1110 may also store information related to a plurality of user's payment accounts. Each user account data includes at least one of a cardholder name, a cardholder address, an account number, MPIN, and other account identifier. The database 1110 may also store information of a plurality of merchants such as travel booking entities. The database 1110 may also include instructions for settling transactions including merchant bank account information. The database 1110 may include multiple storage units such as hard disks and/or solid-state disks in a redundant array of inexpensive disks (RAID) configuration. The database 1110 may include a storage area network (SAN) and/or a network attached storage (NAS) system.

In some embodiments, the database 1110 is integrated within the computer system 1105. For example, the computer system 1105 may include one or more hard disk drives as the database 1110. In other embodiments, the database 1110 is external to the computer system 1105 and may be accessed by the computer system 1105 using a storage interface 1130. The storage interface 1130 is any component capable of providing the processor 1115 with access to the database 1110. The storage interface 1130 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1115 with access to the database 1110.

The processor 1115 is configured to facilitate a payment transaction from an issuer account to an acquirer account. The processor 1115 is configured to one or more of the functions such as: verify the travel booking entity 102, authenticate the customer 104, verify payment card details, check available standing balance in an issuer account of the customer 104, validate the transaction amount and retrieving travel booking information by communicating with the database 1110. The processor 1115 is further configured to facilitate the authentication of the customer 104 by verifying the payment card number, PIN/OTP, validity of the payment card by accessing respective information from the database 1110. Thereafter, the processor 1115 is configured to facilitate the payment transaction of the transaction amount from the issuer account of the user to acquirer account of the travel booking entity 102. The processor 1115 may also be configured to notify the device 108 and the booking interface 106 of the transaction status via the communication interface 1125.

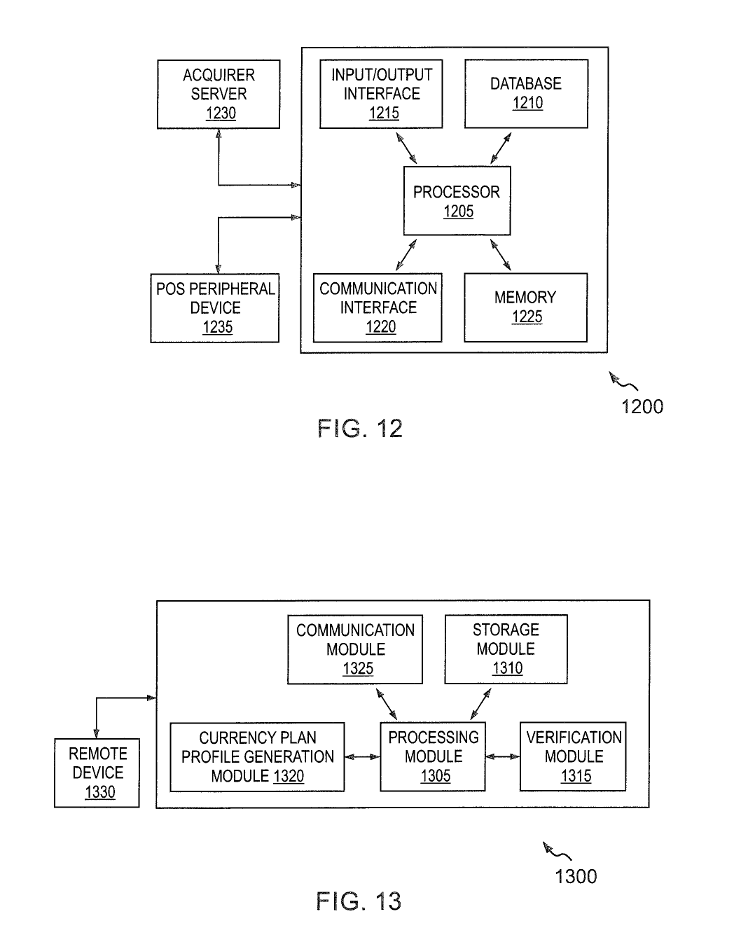

FIG. 12 is a simplified block diagram of a travel booking entity interface (e.g. the booking interface 106) such as a POS terminal 1200 used for payment transactions, in accordance with one embodiment of the present disclosure. The POS terminal 1200 as explained herein is only one example of a merchant device such as a merchant mobile phone, a kiosk, a PDA, a merchant facilitated e-commerce website interface running on a computing device and the like. The POS terminal 1200 includes at least one processor 1205 communicably coupled to a database 1210, an Input/Output (I/O) interface 1215, a communication interface 1220 and a memory 1225. The components of the POS terminal 1200 provided herein may not be exhaustive, and that the POS terminal 1200 may include more or fewer components than that of depicted in FIG. 12. Further, two or more components may be embodied in one single component, and/or one component may be configured using multiple sub-components to achieve the desired functionalities. Some components of the POS terminal 1200 may be configured using hardware elements, software elements, firmware elements and/or a combination thereof.

The I/O interface 1215 is configured to receive inputs from and provide outputs to the end-user (i.e. the merchant and/or the customer) of the POS terminal 1200. For instance, the I/O interface 1215 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 1225 can be any type of storage accessible to the processor 1205. For example, the memory 1225 may include volatile or non-volatile memories, or a combination thereof. In some non-limiting examples, the memory 1225 can be four to sixty four Megabytes (MB) of Dynamic Random Access Memory (“DRAM”) or Static Random Access Memory (“SRAM”). In addition, some examples may include supplementary flash memory installed via a PCMCIA slot.

The database 1210 is capable of storing and/or retrieving data, such as, but not limited to, smart card insertions, user/customer information, merchant information, card swipes, touch-screen key depressions, keypad key depressions, number of dots printed by the slip and roll printers, check read errors, and the like. Such information can be accessed by the processor 1205 using the communication interface 1220 to determine potential future failures and the like.

The POS terminal 1200 is capable of communicating with one or more POS peripheral devices such as the POS peripheral device 1235 and external server system such as an acquirer server 1230 (an example of the acquirer server 116 of FIG. 1) via the communication interface 1220 over a communication network such as the network 120 of FIG. 1. The POS peripheral device 1235 can provide functionality which is used by a consumer at a merchant facility, such as PIN entry, clear text entry, signature capture, and the like. Some non-exhaustive examples of the POS peripheral device 1235 include barcode scanner, cash drawer, magnetic stripe reader, receipt printer, PIN pad, signature capture device, touchscreen, keyboard, portable data terminal, card reader, customer pole display and the like. In some embodiments, the POS terminal 1200 may be mounted near a cash register at a check-out counter at a merchant facility, while the POS peripheral device 1235 may be mounted on the check-out counter such that it is accessible to the customers. In this way, both the merchant and the user/customer can interact with similar devices to process the payment transaction.

The communication interface 1220 is further configured to cause display of user interfaces on the POS terminal 1200. In one embodiment, the communication interface 1220 includes a transceiver for wirelessly communicating information to, or receiving information from, the acquirer server 1230 or other suitable display device, and/or another type of remote processing device. In another embodiment, the communication interface 1220 is capable of facilitating operative communication with the remote devices and a cloud server using Application Program Interface (API) calls. The communication may be achieved over a communication network, such as the network 120.

The processor 1205 is capable of sending the payment transaction request received from the end-user via the communication interface 1220 to the acquirer server 1230 for processing the payment transaction. For example, the processor 1205 is configured to receive the PIN and the transaction amount entered by the end-user using the UIs. The processor 1205 can access the database 1210 to retrieve the user information and merchant information that are required to be sent along with the payment transaction request to the acquirer server 1230.

Additionally, the POS terminal 1200 can include an operating system and various software applications that can provide various functionality to the POS terminal 1200. For example, in some embodiments, the POS terminal 1200 is addressable with an Internet protocol and includes a browser application. In such embodiments, the processor 1205 includes software adapted to support such functionality. In some embodiments, the processor 1205 executes software to support network management. In particular, this capacity allows software to be downloaded to a plurality of such systems to provide new applications such as application for various possible payment methods using POS terminals and/or updates to existing applications. The operating system and software application upgrades are distributed and maintained through communication to the POS terminal 1200 over the network 120.

FIG. 13 is a simplified block diagram of an issuer server 1300 for updating an existing currency plan profile for one or more payment cards of a customer to a currency plan profile for cross-border travel, in accordance with one embodiment of the present disclosure. The issuer server 1300 is an example of the issuer server 114 of FIG. 1, or may be embodied in the issuer server 114. The issuer server 1300 is associated with an issuer bank/issuer, in which a customer may have an account, which provides a payment card. The issuer server 1300 includes a processing module 1305 operatively coupled to a storage module 1310, a verification module 1315, a currency plan profile generation module 1320 and a communication module 1325. The components of the issuer server 1300 provided herein may not be exhaustive and that the issuer server 1300 may include more or fewer components than that of depicted in FIG. 13. Further, two or more components may be embodied in one single component, and/or one component may be configured using multiple sub-components to achieve the desired functionalities. Some components of the issuer server 1300 may be configured using hardware elements, software elements, firmware elements and/or a combination thereof.

The storage module 1310 is configured to store machine executable instructions to be accessed by the processing module 1305. Additionally, the storage module 1310 stores information related to, contact information of the customer, bank account number, availability of funds in the account, payment card details, travel information of customers, and/or the like. This information is retrieved by the processing module 1305 for validation during currency plan profile generation for the payment card. The storage module 1310 also stores the default currency plan profile and latest currency plan profile for each payment card associated with the issuer server 1300.

The processing module 1305 is configured to communicate with one or more remote devices such as a remote device 1330 using the communication module 1325 over a network such as the network 120 or the payment network 112 of FIG. 1. The examples of the remote device 1330 include, the booking interface 106, the device 108, the payment server 118, the acquirer server 116, the global database 122 or other computing systems of issuer and the payment network 112 and the like. The communication module 1325 is capable of facilitating such operative communication with the remote devices and cloud servers using API (Application Program Interface) calls. The communication module 1325 is further configured to cause display of user interfaces (UIs) on the device 108 via the network 120 to enable the customer to receive notification for currency plan profile in the account of the customer for the cross-border travel, provide acceptance or decline of the currency plan profile, provide acceptance or denial of multiple currency based payment card conversion, etc.

The processing module 1305 is further configured to provide instructions to the currency plan profile generation module 1320 to generate a currency plan profile for a payment card of a customer. The processing module 1305 fetches information corresponding to the travel booking request from the remote device 1330 (i.e. the global database 122). From the travel booking request, a travel booking reference number (PNR) is retrieved and from the PNR, information related to one or more foreign destinations and a duration of stay in each of the one or more destinations are fetched. The currency plan profile generation module 1320 may retrieve currency information related to exchange rates of a plurality of currencies worldwide from one or more remote servers/databases. Accordingly, based on the destinations, the duration of stay in each of the destinations and the exchange rates of currencies in the destinations, a currency plan profile is generated.

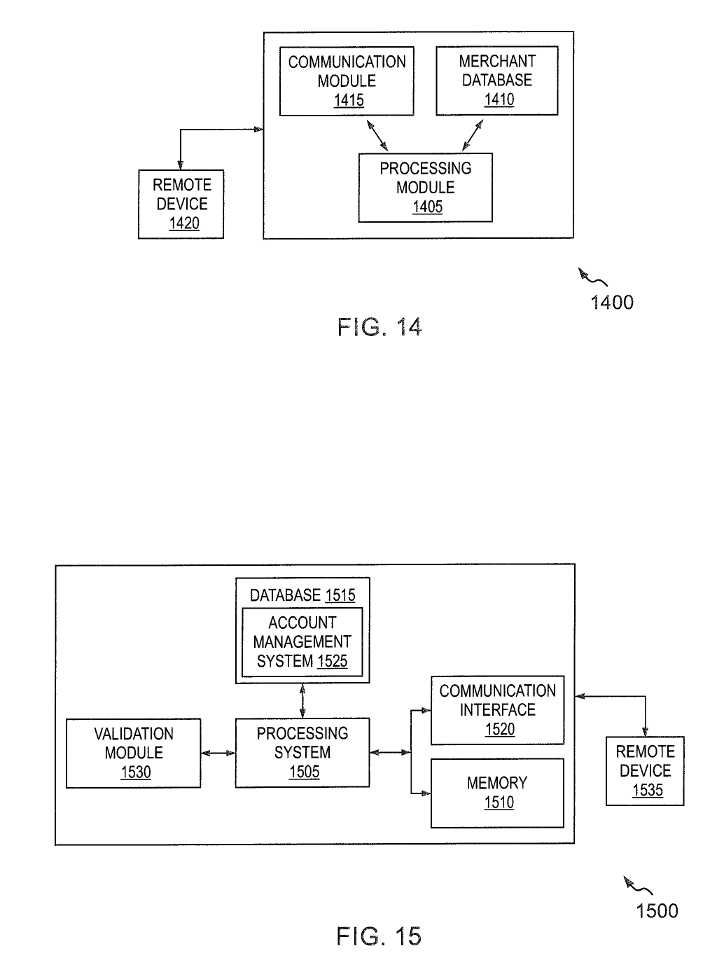

FIG. 14 is a simplified block diagram of an acquirer server 1400 used for updating an existing currency plan profile for one or more payment cards of a customer to a currency plan profile for cross-border travel, in accordance with one embodiment of the present disclosure. The acquirer server 1400 is associated with an acquirer bank, which may be associated with the travel booking entity 102 where the travel booking entity 102 has established an account to accept payment for travel booking from customers. The acquirer server 1400 is an example of the acquirer server 116 of FIG. 1, or may be embodied in the acquirer server 116. Further, the acquirer server 1400 is configured to facilitate payment transaction with the issuer server 1300 using a payment network, such as the payment network 112 of FIG. 1. The acquirer server 1400 includes a processing module 1405 communicably coupled to a merchant database 1410 and a communication module 1415 that can interact with any remote device 1420 (such as POS terminal 1200, the issuer server 1300, etc.). The components of the acquirer server 1400 provided herein may not be exhaustive, and that the acquirer server 1400 may include more or fewer components than that of depicted in FIG. 14. Further, two or more components may be embodied in one single component, and/or one component may be configured using multiple sub-components to achieve the desired functionalities. Some components of the acquirer server 1400 may be configured using hardware elements, software elements, firmware elements and/or a combination thereof.

The merchant database 1410 includes one or more merchant parameters, such as, but not limited to, a merchant primary account number (PAN), a merchant name, a merchant category code (MCC), a merchant city, a merchant postal code, an MAID, a merchant brand name, terminal identification numbers (TIDs) associated with merchant equipment (e.g., the POS terminals or any other merchant electronic devices) used for processing transactions and the like. The processing module 1405 is configured to use the merchant ID or any other merchant parameter such as the merchant PAN to identify the merchant during the normal processing of payment transactions, adjustments, chargebacks, end-of-month fees and so forth. The processing module 1405 may be configured to store and update the merchant parameters in the merchant database 1410 for later retrieval.

FIG. 15 is a simplified block diagram of a payment server 1500 used for updating an existing currency plan profile for one or more payment cards of a customer to a currency plan profile for cross-border travel, in accordance with one embodiment of the present disclosure. The payment server 1500 may correspond to the payment server 118 of FIG. 1. As explained with reference to FIG. 1, the payment server 118 is associated with the payment network 112. The payment network 112 may be used by the issuer server 1300 and the acquirer server 1400 as a payment interchange network. Examples of payment interchange network include, but not limited to, Mastercard® payment system interchange network. The payment server 1500 includes a processing system 1505 configured to extract programming instructions from a memory 1510 to provide various features of the present disclosure. The components of the payment server 1500 provided herein may not be exhaustive, and that the payment server 1500 may include more or fewer components than that of depicted in FIG. 15. Further, two or more components may be embodied in one single component, and/or one component may be configured using multiple sub-components to achieve the desired functionalities. Some components of the payment server 1500 may be configured using hardware elements, software elements, firmware elements and/or a combination thereof.

Via a communication interface 1520, the processing system 1505 receives travel information associated with payment transaction request from a remote device 1535 such as the acquirer server 1400, the booking interface 106 or the device 108. The communication may be achieved through API calls, without loss of generality. An account management system (AMS) 1525 which is embodied in a database 1515 includes the currency plan profile for a payment card of a customer. Apart from the currency plan profile, the AMS 1525 stores the customer parameters, payment card details, travel information, the transaction amount, fund limits, currency exchange rate, expense information, acquirer account information, transaction records, merchant account information, and the like. The customer details, the payment card details, the issuer account balance, etc., are verified using a verification module 1530. The verification module 1530 may include one or more predefined rule sets using which the processing system 1505 can process the verification. Further, the processing system 1505, upon successful verification, sends transaction amount and the merchant parameters to the acquirer server 1400 for crediting the merchant account with the transaction amount. The processing system 1505 is further configured to notify the remote device 1535 of the transaction status via the communication interface 1520. In one embodiment, the processing system 1505 may facilitate a dedicated application capable of being installed on the booking interface 106. The merchant may be enabled to view the transaction status using the application on his device. The merchant may access the application using a web link as well, instead of having a need to install the application on his device.

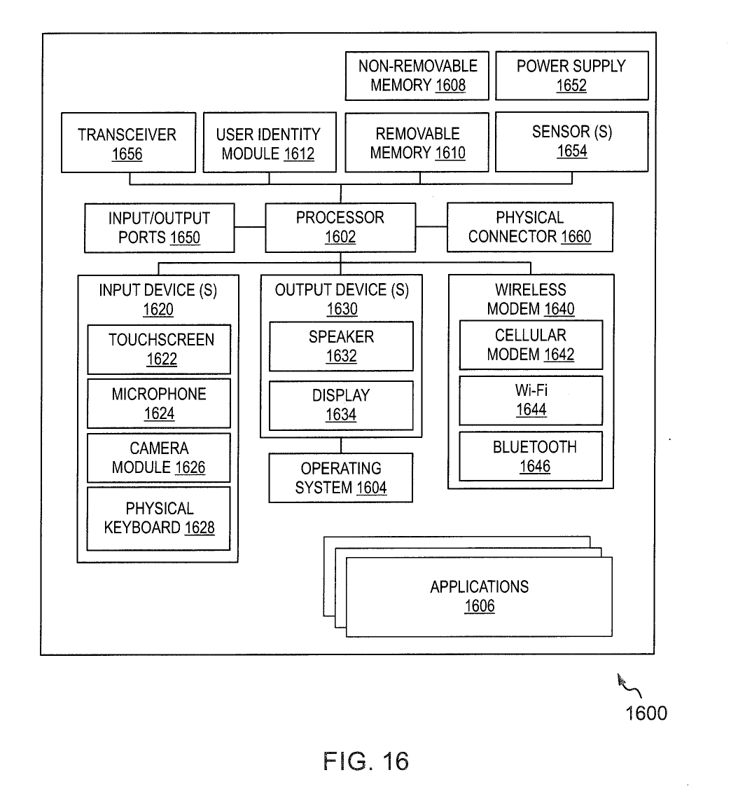

FIG. 16 shows simplified block diagram of a user device, for example, a mobile phone 1600 capable of implementing the various embodiments of the present disclosure. For example, the mobile phone 1600 may correspond to an electronic device of the customer 104. The mobile phone 1600 is depicted to include one or more applications 1606. The mobile phone 1600 is an example of the device 108.

It should be understood that the mobile phone 1600 as illustrated and hereinafter described is merely illustrative of one type of device and should not be taken to limit the scope of the embodiments. As such, it should be appreciated that at least some of the components described below in connection with that the mobile phone 1600 may be optional and thus in an example embodiment may include more, less or different components than those described in connection with the example embodiment of the FIG. 16. As such, among other examples, the mobile phone 1600 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated mobile phone 1600 includes a controller or a processor 1602 (e.g., a signal processor, microprocessor, ASIC, or other control and processing logic circuitry) for performing such tasks as signal coding, data processing, image processing, input/output processing, power control, and/or other functions. An operating system 1604 controls the allocation and usage of the components of the mobile phone 1600 and support for one or more applications programs (see, travel booking applications 1606), that implements one or more of the innovative features described herein. The applications 1606 may include a travel booking application. Alternatively or additionally, the applications 1606 may include common mobile computing applications (e.g., telephony applications, email applications, calendars, contact managers, web browsers, messaging applications such as USSD messaging or SMS messaging or SIM Tool Kit (STK) application) or any other computing application.

The illustrated mobile phone 1600 includes one or more memory components, for example, a non-removable memory 1608 and/or a removable memory 1610. The non-removable memory 1608 and/or the removable memory 1610 may be collectively known as database in an embodiment. The non-removable memory 1608 can include RAM, ROM, flash memory, a hard disk, or other well-known memory storage technologies. The removable memory 1610 can include flash memory, smart cards, or a Subscriber Identity Module (SIM). The one or more memory components can be used for storing data and/or code for running the operating system 1604 and the applications 1606. The mobile phone 1600 may further include a user identity module (UIM) 1612. The UIM 1612 may be a memory device having a processor built in. The UIM 1612 may include, for example, a subscriber identity module (SIM), a universal integrated circuit card (UICC), a universal subscriber identity module (USIM), a removable user identity module (R-UIM), or any other smart card. The UIM 1612 typically stores information elements related to a mobile subscriber. The UIM 1612 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The mobile phone 1600 can support one or more input devices 1620 and one or more output devices 1630. Examples of the input devices 1620 may include, but are not limited to, a touch screen/a display screen 1622 (e.g., capable of capturing finger tap inputs, finger gesture inputs, multi-finger tap inputs, multi-finger gesture inputs, or keystroke inputs from a virtual keyboard or keypad), a microphone 1624 (e.g., capable of capturing voice input), a camera module 1626 (e.g., capable of capturing still picture images and/or video images) and a physical keyboard 1628. Examples of the output devices 1630 may include, but are not limited to a speaker 1632 and a display 1634. Other possible output devices can include piezoelectric or other haptic output devices. Some devices can serve more than one input/output function. For example, the touch screen 1622 and the display 1634 can be combined into a single input/output device.

A wireless modem 1640 can be coupled to one or more antennas (not shown in the FIG. 16) and can support two-way communications between the processor 1602 and external devices, as is well understood in the art. The wireless modem 1640 is shown generically and can include, for example, a cellular modem 1642 for communicating at long range with the mobile communication network, a Wi-Fi compatible modem 1644 for communicating at short range with an external Bluetooth-equipped device or a local wireless data network or router, and/or a Bluetooth-compatible modem 1646. The wireless modem 1640 is typically configured for communication with one or more cellular networks, such as a GSM network for data and voice communications within a single cellular network, between cellular networks, or between the mobile phone 1600 and a public switched telephone network (PSTN).

The mobile phone 1600 can further include one or more input/output ports 1650, a power supply 1652, one or more sensors 1654 for example, an accelerometer, a gyroscope, a compass, or an infrared proximity sensor for detecting the orientation or motion of the mobile phone 1600 and biometric sensors for scanning biometric identity of an authorized user, a transceiver 1656 (for wirelessly transmitting analog or digital signals) and/or a physical connector 1660, which can be a USB port, IEEE 1294 (FireWire) port, and/or RS-232 port. The illustrated components are not required or all-inclusive, as any of the components shown can be deleted and other components can be added.

The disclosed methods with reference to FIGS. 1 to 8, or one or more operations of the flow diagram 900 and 1000 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 1100 (e.g. the servers 114, 116 and 118) and its various components such as the computer system 1105 and the database 1110 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A method, comprising:
facilitating, by an issuer server of a payment network, a payment transaction between an issuer account associated with a payment card of a customer and an acquirer account associated with a travel booking entity, the payment transaction associated with a foreign travel booking request for travel in one or more foreign destinations;
generating, by the issuer server, a currency plan profile for the payment card, the currency plan profile generated in response to one or more travel details of the foreign travel booking request;
providing the currency plan profile to the customer for approval of the customer; and
upon receipt of the approval of the currency plan profile from the customer, updating an existing currency plan profile of the payment card to the currency plan profile for facilitating a future payment transaction from the issuer account when the payment card is used to make a transaction in a foreign destination of the one or more foreign destinations.

2. The method as claimed in claim 1, wherein generating the currency plan profile comprises:
accessing a travel booking reference number associated with the foreign travel booking request from a global database;
receiving the one or more travel details from the global database based on the travel booking reference number; and
determining the currency plan profile based on the one or more travel details.

3. The method as claimed in claim 2, wherein the one or more travel details comprise the one or more foreign destinations and duration of stay in each of the one or more foreign destinations.

4. The method as claimed in claim 1, wherein generating the currency plan profile further comprises:
accessing the one or more travel details from a global database; and
determining the currency plan profile including an improved exchange rate for a travel base currency from a base currency based on the foreign destination of the one or more foreign destinations, duration of stay at the foreign destination and one or more deals an issuer associated with the issuer server has with merchants in the foreign destination.

5. The method as claimed in claim 1, wherein generating the currency plan profile further comprises facilitating a travel fund limit in the currency plan profile of the payment card for a duration of stay in the foreign destination of the one or more foreign destinations.

6. The method as claimed in claim 1, wherein the currency plan profile comprises at least one of: a travel base currency in each of the one or more foreign destinations; an exchange rate for the travel base currency from a base currency associated with the payment card or a default exchange rate for the travel base currency from a base currency associated with the payment card; a fund limit for payment card in the travel base currency; and a validity period of the currency plan profile.

7. The method as claimed in claim 1, wherein providing the currency plan profile comprises sending a notification of the currency plan profile to a customer account of the customer with the issuer server.

8. The method as claimed in claim 1, wherein updating the existing currency plan profile to the currency plan profile comprises storing the currency plan profile in a database.

9. The method as claimed in claim 1, wherein updating the existing currency plan profile to the currency plan profile comprises providing the currency plan profile to a payment server of the payment network for storing the currency plan profile at a storage location accessible to the payment server.

10. The method as claimed in claim 1, further comprising:
receiving a currency plan profile deactivation request for deactivating the currency plan profile;
deactivating the currency plan profile associated with the payment card; and updating the currency plan profile of the payment card to a default currency plan profile of the payment card.

11. The method as claimed in claim 1, wherein the payment card is at least one of: a credit card and a debit card.

12. The method as claimed in claim 1, wherein the foreign travel booking request is initiated using an online mode or an offline mode.

13. An issuer server in a payment network, comprising:
a memory comprising stored instructions; and
at least one processor, configured to execute the stored instructions to cause the issuer server to perform at least:
facilitating a payment transaction between an issuer account associated with a payment card of a customer and an acquirer account associated with a travel booking entity, the payment transaction associated with a foreign travel booking request for travel in one or more foreign destinations;
generating a currency plan profile for the payment card, the currency plan profile generated in response to one or more travel details of the foreign travel booking request;
providing the currency plan profile to the customer for approval of the customer; and
upon receipt of the approval of the currency plan profile from the customer, updating an existing currency plan profile of the payment card to the currency plan profile for facilitating a future payment transaction from the issuer account when the payment card is used to make a transaction in a foreign destination of the one or more foreign destinations.

14. The issuer server as claimed in claim 13, wherein for generating the currency plan profile, the issuer server is further caused to perform at least:
accessing a travel booking reference number associated with the foreign travel booking request from a global database;
receiving the one or more details from the global database based on the travel booking reference number; and
determining the currency plan profile based on the one or more travel details.

15. The issuer server as claimed in claim 14, wherein the one or more travel details comprise the one or more foreign destinations and duration of stay in each of the one or more foreign destinations.

16. The issuer server as claimed in claim 13, wherein the currency plan profile comprises at least one of: a travel base currency in each of the one or more foreign destinations; an exchange rate for the travel base currency from a base currency associated with the payment card; a fund limit for payment card in the travel base currency; and a validity period of the currency plan profile.

17. A method, comprising:
facilitating, by a payment server of a payment network, a payment transaction between an issuer account associated with a payment card of a customer and an acquirer account associated with a travel booking entity, the payment transaction associated with a foreign travel booking request for travel in one or more foreign destinations;
accessing, by the payment server, a currency plan profile for the payment card, the currency plan profile generated in response to one or more travel details of the foreign travel booking request; and
storing the currency plan profile, upon receipt of approval of the currency plan profile from the customer, in a database accessible to the payment server for facilitating a future payment transaction from the issuer account when the payment card is used to make a transaction in a foreign destination of the one or more foreign destinations.

18. The method as claimed in claim 17, wherein facilitating future payment transaction from the issuer account further comprises reading the currency plan profile from the database accessible to the payment server and verifying a travel base currency in the one or more foreign destinations.

19. The method as claimed in claim 17, wherein the one or more travel details comprise the one or more foreign destinations and duration of stay in each of the one or more foreign destinations.

20. The method as claimed in claim 17, wherein the currency plan profile comprises at least one of: a travel base currency in each of the one or more foreign destinations, an exchange rate for the travel base currency from a base currency associated with the payment card, a fund limit for payment card in the travel base currency and a validity period of the currency plan profile.
